(19) United States
(12) Patent Application Publication
(10) Pub. No.: US 2009/0219245 A1
(43) Pub. Date: Sep. 3, 2009

(54) DIGITAL PICTURE FRAME

(75) Inventors: Charles H. Frankel, Denver, CO (US); Morgan C. Jones, Longmont, CO (US); Arthur D. Truesdell, Carlsbad, CA (US)

Correspondence Address: Hiscock & Barclay, LLP, One Park Place, 300 South State Street, Syracuse, NY, 13202-2078, US

(73) Assignee: Smart Parts, Inc., Providence, RI (US)

(21) Appl. No.: 12/040,731

(22) Filed: Feb. 29, 2008

(51) Int. Cl. G09G 3/34

(52) U.S. Cl. 345/104

(57) ABSTRACT

A method, apparatus and system for display of digital images that provides for duplicate file detection, dynamic simultaneous and sequential display of multiple images, user modifiable image display sequences, operating mode transition based upon motion sensing and automatic and selective transfer of images from external devices without requiring user or other human intervention.

### CROSS-REFERENCE TO RELATED APPLICATIONS

This application claims priority to U.S. Provisional Patent Application filed Feb. 28, 2008 and titled “Digital Picture Frame”, having an Attorney Docket/Matter No.: 3028310 US01 and Ser. No. that has not yet been assigned, and to U.S. Provisional Patent Application filed Feb. 29, 2008 and titled “Digital Picture Frame”, having an Attorney Docket/Matter No.: 3028310 US01 and Ser. No. that has not yet been assigned, the entirety of which are incorporated herein by reference.

### CROSS-REFERENCE TO APPLICATIONS INCLUDING RELATED SUBJECT MATTER

This application includes subject matter related to U.S. Design patent application Ser. No. 29/296,952 that was filed Oct. 31, 2007 and titled “An Ornamental Design for a Digital Picture Frame”, having an Attorney Docket/Matter No.: 3028309 US01 and is incorporated herein by reference in its entirety.

### FIELD OF THE INVENTION

This invention relates generally to an apparatus configured for display of digitally encoded images, such as digital photographs that are captured by a digital camera.

### BACKGROUND OF THE INVENTION

Use of digital cameras has created collections of digital photographs. A digital camera itself, is typically capable of displaying a image within a small electronic display residing within it. Unlike that of a digital camera, a digital picture frame is a separate device that is capable of displaying a digital image, such as a digital photograph, within a larger physical area and at a higher resolution than that provided by a typical digital camera.

### SUMMARY OF THE INVENTION

The invention provides for a method, apparatus and a system for dynamic, simultaneous and/or sequential display of multiple images, user modifiable image display sequences, operating mode transition based upon motion sensing and automatic and selective transfer of images from external devices without requiring user (human) intervention. The foregoing as well as other objects, aspects, features, and advantages of the invention will become more apparent from the following description and from the claims.

### BRIEF DESCRIPTION OF THE DRAWINGS

The objects and features of the invention can be better understood with reference to the claims and drawings described below. The drawings are not necessarily to scale, the emphasis is instead generally being placed upon illustrating the principles of the invention. Within the drawings, like reference numbers are used to indicate like parts throughout the various views. Some differences between otherwise like parts may cause those parts to be each indicated by different reference numbers. Unlike parts are indicated by different reference numbers.

FIG. 1 illustrates a front perspective view of an embodiment of digital picture frame.

FIG. 2 illustrates a rear perspective view of the embodiment of the digital picture frame of FIG. 1.

FIG. 3A is a simplified block diagram of some of the internal components residing within a chassis of the digital picture frame of FIGS. 1 and 2.

FIG. 3B illustrates a top view perspective of an embodiment of motion sensor functionality of the digital picture frame.

FIG. 4 illustrates a set of C programming language source code 400 representing one embodiment of an file identification procedure.

FIGS. 5A-5D illustrate a dynamic image display scenario according to one embodiment of the invention.

### DETAILED DESCRIPTION OF THE INVENTION

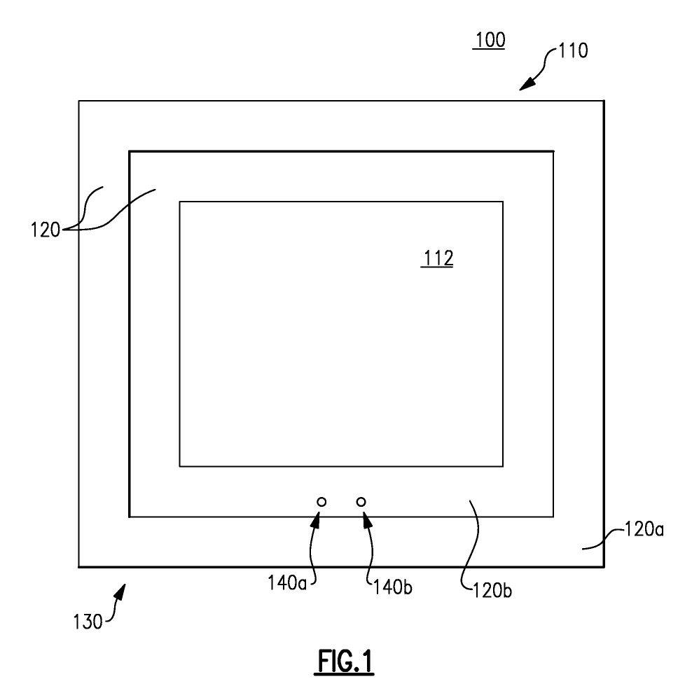

FIG. 1 illustrates a front perspective view 100 of an embodiment of digital picture frame. As shown, an outer front surface 130 of the digital picture frame (DPF) 110 includes a display screen 112 and a frame 120 that surrounds the display screen 112. The embodiment of the frame 120 shown is divided into an outer portion 120a and an inner portion 120b. The frame 120 is also referred to herein as a sash 120. The outer surface of the digital picture frame is also referred to as the chassis of the DPF 110.

The display screen 112, also referred to herein as a display 112, is configured to display (render) at least a portion of an image at one point in time. The display screen 112 includes a plurality of pixels that are each configured to project light. The light projecting from each pixel has characteristics, including such as color, hue and luminosity that are distinctly associated with each pixel.

A motion sensor resides within the chassis of the DPF 110. Two motion sensor passageways 140a-140b are located on a lower side of the inner portion 120b of the frame 120 of the DPF 110. In this embodiment, the motion sensor outputs infrared (IR) radiation via passageway 120a and inputs IR radiation via passageway 120b.

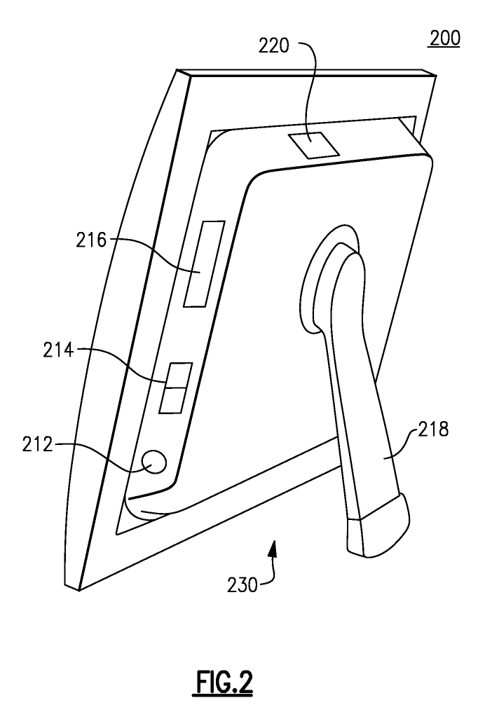

FIG. 2 illustrates a rear perspective view 200 of the embodiment of the digital picture frame of FIG. 1. As shown, the outer rear surface 230 of the digital picture frame (DPF) 112 includes various externally accessible components, including controls and receptacles, of the DPF 112. These externally accessible components include a power input receptor (jack) 212, one or more universal serial bus (USB) ports 214, one or more memory card receptor slots 216, a stand interface 218, and a control button 220.

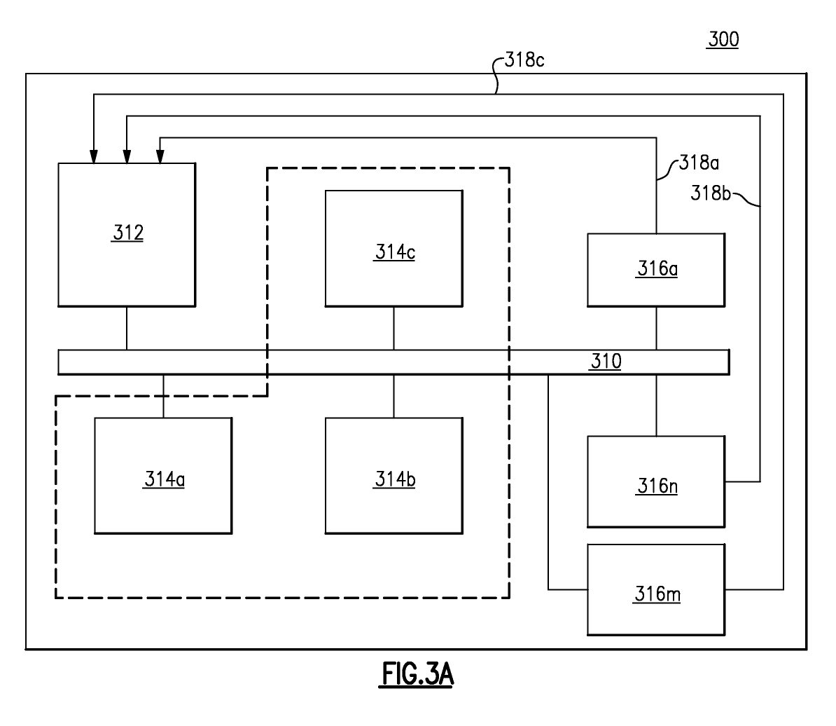

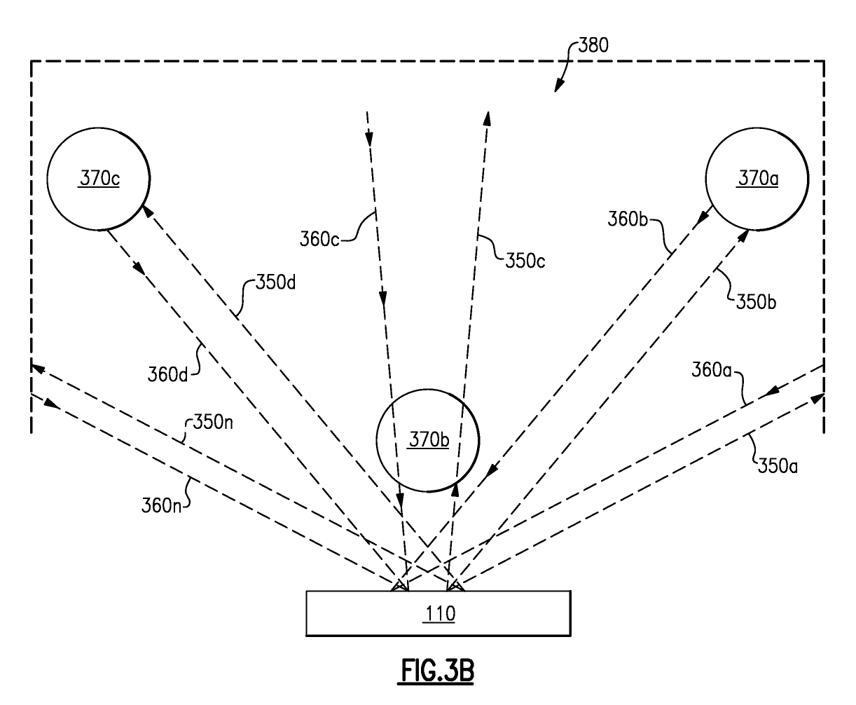

FIG. 3A is a simplified block diagram 300 of some of the internal components residing within the chassis 320 of the digital picture frame 110 of FIGS. 1 and 2. In this embodiment, the internals of the DPF 110 include at least one of each of the following types of components, a bus 310, an instruction processor 312, memory 314 and one or more input/output interface components 316a-316n. The instruction processor 312 is also referred to as a central processing unit (CPU). The memory 314 residing within the chassis 320 is also referred to herein as internal memory 314. In some embodiments, the instruction processor 312 is an model IS-5120 processor supplied by InSilica of Santa Clara, Calif. The IS-5120 is an ARM type of processor, which is well known to those skilled in the art. In this embodiment, the bus 310 is selected to be compatible with the ARM processor family, and specifically with the IS-5120. In other embodiments, many other processors and/or bus designs can be employed in accordance with the invention.

One or more input/output interface components 316a-316n are designed to provide an interface (intermediary) between the bus 310 and/or instruction processor 312 and one or more other ports and/or components that function as a part of the DPF 110 and that interact with entities that are located outside of the DPF 110. These other ports and/or components include such as one or more USB (insertion) ports 214 and/or one or more memory card (insertion) slots 216, and/or one or more motion detection components and/or various other types of ports/components that interact with or be accessible by entities (people and/or devices) that are located external to the chassis of the DPF 110, for example.

In some embodiment, these components 316a-316n can also be implemented as an interface (intermediary) to other components that are located internal to the DPF 110, and that do not interact with or are accessible by entities (people and/or devices) that are located external to the chassis of the DPF 110. For example, a component 316a-316n could instead, interface with an internal clock of the DPF 110, for example.

Furthermore, in some embodiments, the one or more input/output interface components 316a-316n can be implemented other than as an interface (intermediary), and instead be implemented as the other port and/or component itself, that functions as part of the DPF 110. For example, in some embodiments, the component 316m is implemented as a motion sensor itself, and not as an interface (intermediary) to another motion sensor component.

As shown, at least one interrupt mechanism 318a-318n enables each of at least one or more of the input/output interfaces 316a-316n respectively, to interrupt the instruction processor 312 upon an occurrence of a event of interest. An event of interest includes for example, an action of inserting a memory card into a memory slot 216, an action of inserting a USB memory device into a USB port 214 or an action of motion sensor scanning of entities that are located within proximity of the DPF 110.

Upon an occurrence of an event of interest, an interrupt signal, associated with the particular event of interest and a particular input/output interface 316a-316n, is communicated via an interrupt mechanism 316a-316n to the instruction processor 312. In some embodiments and as shown, the interrupt mechanism 318a-318n is implemented as an interrupt line 318a-318n, that is configured to provide an electronic connection between a respective input/output interface 316a-316n and a respective interrupt input line of the instruction processor 312. The instruction processor 312 is configured to incorporate a plurality of interrupt input lines, that are typically indexed and numbered.

The interrupt input line 318a-318n, also referred to herein as an interrupt line 318a-318n, is typically implemented as a conductive path over which an interrupt signal is transmitted from an input/output interface 316a-316n to the instruction processor 312. The instruction processor 312 responds to receiving a particular interrupt signal from an interrupt line 318a-318n by performing a predetermined set of actions that are associated with the particular interrupt, which indicates the occurrence of an event of interest.

The memory 314 within the DPF 110 can be comprised of a combination of multiple types of individual memory components, such as various types of random access memory (RAM) and flash memory. A RAM memory component 314a is a volatile (power dependent) form of random access memory (RAM). A flash memory component 314b is a non-volatile (power independent) type of random access memory (RAM). A NAND flash memory component 314c is a non-volatile (power independent) type of random access memory (RAM) that is typically employed for storing digital image information, such as for storing digital photographs.

The digital picture frame 110 includes software (not shown) that is embodied as a set of instructions targeted for and executable by the processor 312. The software directs the operation of the processor, which in turn directs the operation of the DPF 110. A copy of the software is stored within a non-volatile portion of the memory 314, at least for a period of time while the DPF 110 is powered off. Upon power up, the DPF 110 optionally copies at least a portion of the software to other volatile or non-volatile memory 314 and executes the software as it is stored within that memory 314.

FIG. 3B illustrates a top view perspective of an embodiment of motion sensor functionality of the digital picture frame. In some embodiments of the DPF 110, a motion sensor device is employed to detect the presence and/or motion of entities that reflect IR radiation and that are located external to the DPF 110. Within the DPF 110, various embodiments of motion sensing can be implemented. In some embodiments, the motion sensor apparatus includes an infrared (IR) light emitting diode (LED) and an infrared (IR) detector implemented as a IR photodiode. The LED outputs IR radiation from the DPF 110 via passagewat 140a and the IR detector inputs IR radiation into the DPF 110 via passageway 140b. In this embodiment, the motion sensor apparatus is included within component 316mand interfaces with the internal components of FIG. 3, such as the bus 310 and the instruction processor 312, as shown in FIG. 3.

In some embodiments, the motion sensor 316m can be implemented using a infrared remote control apparatus normally utilized for remote control of a commercial electronic device (CED), such as utilized for remote control of a television, for example. This type of embodiment is referred to herein as the commercial electronic device (CED) embodiment. This type of embodiment is can be implemented using the Sharp Model GP1UD261XK infrared component, for example.

As shown, the motion sensor device, outputs (emits) IR radiation in a direction towards a target area 380. The IR radiation that is output from the DPF 110, via passageway 140a, is represented by a plurality of dashed arrows 350a-350n. The IR radiation that is input from the DPF 110, via passageway 140b, is represented by a plurality of dashed arrows 360a-360n. The target area 380 is a volume of space adjacent to the front surface of the DPF 110, and infrared (IR) reflecting entities 370a-370c, such as living and non-living entities, for example people and other non-living things respectively, are located within the target area 380.

In the CED embodiment, the IR radiation output can simply be equivalent to that of a button press, such as generated by pressing a numeric button number “5” on a CED remote control device. The IR radiation is input using a IR receiver of a commercial electronic device (CED), also referred to herein as a CED IR receiver. In the CED embodiment, the CED IR receiver simply determines whether it received a button number “5” IR signal and provides a binary indication (YES or NO) as to whether it has detected (recognized) receiving a button number “5” signal.

Each output of IR radiation and following input of reflected IR radiation, in response to the output of IR radiation, is collectively referred to herein as a scanning cycle. In some embodiments, each scanning cycle occurs within a time period of approximately 10 milliseconds. For each scanning cycle, the motion sensor 316m stores into memory 314 a binary scanning cycle result, YES or NO with respect to whether an IR radiation reflection has occurred within the scanning cycle. Optionally time and other related information is stored with the result. After storing information associated with the scanning cycle, the motion sensor notifies the processor 312 via a corresponding input/output interface 316m that generates an interrupt signal via a corresponding interrupt mechanism 318m.

In response to receiving the interrupt signal 318m, the instruction processor 312 executes an interrupt handling procedure constituting one or more instructions starting at a particular memory address. The memory address is associated with the particular interrupt signal (interrupt vector) indicating a motion scanning event. Typically, the memory address is located within memory 314 as a portion of an interrupt vector table. An interrupt vector represents a memory address of an instruction. These one or more instructions constitute at least a portion of an interrupt handling procedure associated with the particular interrupt signal and mechanism 318m, namely a motion scanning interrupt handling (MSIH) procedure.

In some embodiments, the power level, also referred to as a drive strength, of the IR output is varied over time so that an IR reflection corresponding to each individual power level can be compared against reflections corresponding to other power levels occurring near in time to determine motion of any IR reflecting entity within a range of the IR output. An IR output having a maximum power also yields a maximum range from within which a reflection can occur and be detected as IR radiation input.

In some embodiments, a plurality of consecutive scanning cycles a different power levels are performed for collective analysis for detecting motion of an entity 370a-370c. In some embodiments, (10) scanning cycles, referred to a scanning cycle group, are performed within 100 milliseconds at the start of each 60 second period.

The MSIH procedure records in memory 314 a time of occurrence of the motion scanning event and compares information associated with the current motion scanning event with information associated with one or more prior motion scanning events. The MSIH procedure determines if there is a difference between the reflection information of the current scanning cycle as compared to the scanning information of one or more previous scanning cycle.

For example, a scanning cycle performed at a low power level has an associated reflection range of 3 feet. A scanning cycle performed at a higher power level has an associated reflection range of 8 feet. During a first scanning cycle group performed at a first time, only a reflection is returned at the higher power level and not at the lower power level. During a second scanning cycle group, performed at a second time, a reflection is returned within scanning cycles associated with both the lower and higher power levels. This IR reflection scenario is an indication of movement in depth of an entity within the target area. The entity has apparently moved from a location between 3-8 feet from the DPF 110 to a location within 3 feet of the DPF 110. A scanning cycle group including (10) scanning cycles provides for fine discrimination between different reflection ranges.

In some embodiments, the DPF 110 operates in an active (ON) or sleep delay (OFF) mode. When the DPF 100 is operating in an active (ON) mode, the MSIH procedure determines if a motion event has occurred within a prior period of time, referred to as a motion event look back period. In some embodiments, the motion event look back period is configurable. For example, the motion event look back period can be set to equal to 10 minutes, in other embodiments it is set to equal 60 minutes.

In this embodiment, if the DPF 110 is operating in an ON (Active) mode and no motion has been recorded for a look back time period, the MSIH handler will transition the DPF 110 into the sleep delay (inactive) mode where images are no longer automatically displayed. Else, if motion has been detected within a look back time period, then the DPF remains in the on (active) mode and continues to automatically display images.

In this embodiment, if the DPF 110 is operating in the sleep delay (inactive) mode and motion is detected, the MSIH handler will transition the DPF 110 into the ON (Active) mode. Else, if no motion has been detected, the DPF remains in the sleep delay (Inactive) mode and continues to not display images.

In accordance with the invention, the software includes at least one file identification procedure. The file identification procedure is employed to uniquely identify each file that is accessible to the DPF 110 and further, to detect duplicate files, including duplicate image files. A pair of image files that each include a different image, are different files because each includes, at least in part, different data. The file identification procedure can be used to detect image files that each include a different image. Hence, the file identification procedure is also referred to herein as the image file identification procedure, or the image identification procedure.

Employment of an image file identification procedure enables the DPF 110 to quickly and efficiently determine, with a high likelihood, whether (2) separate files are not identical. Such a capability enables at least one valuable feature of the DPF 110 to be implemented. For example, when image files are being transferred to the DPF 110 from an external device, one or more image files that are stored onto an external device can identified as being not identical or most likely a duplicate of one or more image files previously stored within the DPF 110. An image file that is identified as most likely a duplicate of another image file can be identified and processed differently than other image files.

An image file includes digitally encoded data that represents an image and information associated with that image. Within an image file, an image can be represented in a variety of different ways. For example, an image can be represented in accordance in a particular image format, and further, may be compressed and/or encrypted in accordance with the particular image format. An image format typically includes header data which is employed to store information associated with the image and image data which represents the image itself. One such format is the JPEG format which is typically compatible with the design of digital cameras.

In accordance with the invention, the file identification procedure also referred to herein as the procedure, reads at least a portion of the data of an image file and processes that data as a sequence of numerical values. The sequence of numerical values, also referred to herein as a sequence of input values (input data), is read and input into the file identification procedure. In response to the input data, the procedure processes according to a set of predefined steps, the sequence of input values and maps the input values to a sequence of one or more output values. The process of mapping to (determining) the sequence of one or more output values is dependent upon the particular sequence of input values.

The file identification procedure is designed (configured) such that input of a particular sequence of input values yields one and only one sequence of output values. Further, the particular sequence of output values are, with a high likelihood, uniquely associated with the particular set of input values. In other words, another sequence of input values would be mapped with a high likelihood, to a different sequence of output values. Also, a different sequence of output values, with a high likelihood, would have been mapped from a different sequence of input values.

The unique sequence of one or more output values is employed by the DPF 110 as a compact and unique representation (identification) of a file, such as an image file or other type of file that is accessible to the DPF 110. Accordingly, an output sequence associated with a particular file is referred to as the file identifier for that particular file, or optionally referred to as the image file identifier for a particular image file. The procedure can be designed so that the file identifier (output sequence) can be far smaller in size in terms of bytes of digital data storage, than the amount of data required to store the input sequence, which constitutes at least a portion of the data stored within the file. Hence, the output sequence functions not only as a unique identifier, but also an efficient (compact) identification of an file.

Using the above described method, the unique identification of each image file enables the DPF 110 to discriminate with high likelihood, between identical (duplicate) and different image files, not necessarily based upon any label associated with each image file, but instead based upon the unique characteristics of at least a portion of the data stored within each image file. The term “high likelihood” is intended to mean that if (2) separate and different image files were randomly selected, the file identification procedure would output different file identifiers associated with each of the two randomly selected files, with a probability of greater than or equal to 95%.

The file identification procedure is designed so that if a first file and a second file are identical (duplicate) to each other, then a first file identifier computed in association with the first file, and a second file identifier computed in association with a second file, will also be identical (equal) to each other. The algorithm is also designed so that if a first file and a second file are not identical to each other, then a first file identifier computed in association with the first file and a second file identifier computed in association with the second file, will with a high likelihood, not be identical (equal) to each other.

The digital size of the file identifier serves as a relatively compact representation of each file and its content, as compared to the actual size of each file itself. If a first file identifier, that is computed in association with a first image file, is equal to a second image file identifier that is computed in association with a second image file, then with a high likelihood, the first image stored within the first (image) file is identical (a duplicate) of the second image stored within the second (image) file.

Conversely, if a first file identifier, that is computed in association with a first image file, is not equal to a second file identifier that is computed in association with a second image file, then with a high likelihood, the first image file is not identical to and is different from the second image file, and it is likely that the first image stored within the first (image) file is not equal to a second image stored within the second (image) file.

In some embodiments, the file identification procedure employs a set of one or more mathematical operations upon the sequence of input values. In other embodiments, the file identification procedure performs a set of one or more non-mathematical operations upon the sequence of input values. For example, the procedure can map each member (element) of a sequence of input values to another value listed within a table via a table lookup procedure. Optionally, the table lookup procedure could employ random or pseudo random numbers within its table. This technique is known to be used within what is classified as a hash or encryption procedure. In yet other embodiments, the file identification procedure is implemented as a combination of mathematical and non-mathematical operations.

FIG. 4 illustrates a set of C programming language source code 400 representing one embodiment of a file identification procedure 400. The procedure 400 reads at least a portion of data stored within a file into an array named “data” 452. After reading the file data, elements of the array 452 store the file data. Each element of the array 452 is then read and processed by the file identification procedure to cause modification of a value of a variable named “chksum” 454.

In this embodiment, a maximum total of the first 4096 bytes of the file data are read and processed. Each byte of file data is read and stored into an “unsigned char” data type, an element of the array 452, and processed by the procedure. Each byte of file data that is read is also processed in a manner that potentially modifies an integer value (4 bytes) named “chksum” 450 that is stored into a first integer array element named “ipt[0]” 456. Additionally, the number of bytes of file data that is read is stored into a second integer array element named “ipt[1]” 458.

An array named “tmpbuf” 460 stores both the ipt[0] 456 and ipt[1] 458 integer values which form a sequence (ordered pair) of output values, that constitutes a file identifier output by the file identification procedure 400. This procedure is designed so that if the same file was read and processed a second, third or Nth time, the same file identifier, having the same sequence of one or more values (ipt[0] 456 and ipt[1] 458), would be output by the file identification procedure 400.

The above described embodiment, is typically classified as a type of “checksum” procedure. A checksum procedure processes input data according to a particular algorithm that performs mathematical operations in response to the input data and outputs a “checksum value” that is a dependent upon the input data. There are countless varieties of checksum algorithms that can function as an file identification procedure.

In accordance with the invention, other types of procedures, such as those that perform non-mathematical or a combination of mathematical and non-mathematical operations, can be employed to function as a file identification procedure, providing that the file identification procedure outputs identical file identifiers associated with identical files, and with a high likelihood, outputs non-identical file identifiers associated with non-identical files. Furthermore, file identifiers are preferably compact in size (bytes of data), as compared to the size (bytes of data) of an image file itself.

The DPF 110, includes an image file filtering component that employs the file identification procedure, to generate and associate a file identifier with each image file stored within a first set of image files that are stored within the internal memory 314 of the DPF 110. In this embodiment, the image filtering component is implemented as software that is designed to execute via the instruction processor 312 and that directs the operation of the DPF 110.

When an external memory, such as a memory card storing a second set of image files, is inserted within a port, also referred to as an input port, such as a memory card receptor slot 216, the DPF 110 initiates establishment of communication with the memory card via an interrupt mechanism 318a-318n that is activated by a respective input/output port 316a-316n that interfaces with the memory card receptor slot 216. Activation of an interrupt mechanism 318a-318n includes transmission of an interrupt signal, also referred to as a hardware interrupt, from a respective input/output port 318a-318n to the instruction processor 312.

In this embodiment, the interrupt signal functions to cause the instruction processor 312 to execute instructions starting at a particular memory address associated with the particular interrupt signal that is communicated via a particular interrupt mechanism 318a-318n, within the internal memory 314 of the DPF 110. Those particular instructions constitute at least a portion of an interrupt handling procedure associated with the particular interrupt signal and mechanism 318a-318n. Hence, the software within the DPF 110 detects the interrupt event via execution an interrupt handling procedure.

The interrupt handling procedure initiates establishment of communication between the DPF 110 and the memory card. Before executing the interrupt handling procedure, the instruction processor 312 saves its current state of execution in memory 314, so that the instruction processor 312 can resume execution at the current state of execution, after completing execution of the interrupt handling procedure. Upon execution, the interrupt handling procedure, among other actions, accesses the second set of image files stored within the memory card.

In some embodiments, the interrupt handling procedure further generates and associates a file identifier for each image of the second set image files. Upon generating a file identifier for each of the first and second set of image files, the software determines if any of the second set of image files stored within the memory card are identical to (duplicates of) any of the first set of images stored within the internal memory of the DPF 110, by comparing file identifier values that are each associated with an image file.

A pair of image files having identical associated file identifier values are classified as being identical, and duplicates of each other. Image files of the second set that are not classified as duplicates of any image files within the first set, are included as members within a third set of image files.

In some embodiments, the DPF 110 is configured to automatically transfer into its internal memory 314, image files of the third set, which represent image files of the second set that are not duplicates of any of the image files of the first set. This procedure is referred to as automatic and selective transfer of image files from the external memory to the internal memory 314 of the DPF 110. Software, referred to as an image filtering component, is executed as a result of the execution of the interrupt handling procedure and performs this automatic and selective transfer of image files, also referred to as “no click transfer” of image files, without requiring any user or other human intervention after the insertion of the memory card into the input port 216.

In other embodiments, the DPF 110 is configured to automatically transfer into its internal memory, image files of the second set of image files. In this embodiment, the interrupt handling procedure forgoes execution of the image filtering component and as a result, forgoes a determination of whether any of the second set of image files are duplicates of any of the first set of image files, and simply transfers one or more image files from the external memory into the internal memory of the PDF 110. Hence, image files from external memory are transferred, whether or not any are duplicates of image files of the first set that are stored within the PDF 110. The software performs this automatic transfer, also referred to as “no click transfer” of image files, without requiring any user or other human intervention after the insertion of the memory card into the input port 216

Optionally, the software can be configured to automatically display at least one of the transferred image files after the automatic transfer of the image files from the external memory card to the DPF 110. The software performs the automatic display of the transferred image files without requiring any user or other human intervention after detecting the insertion of the memory card.

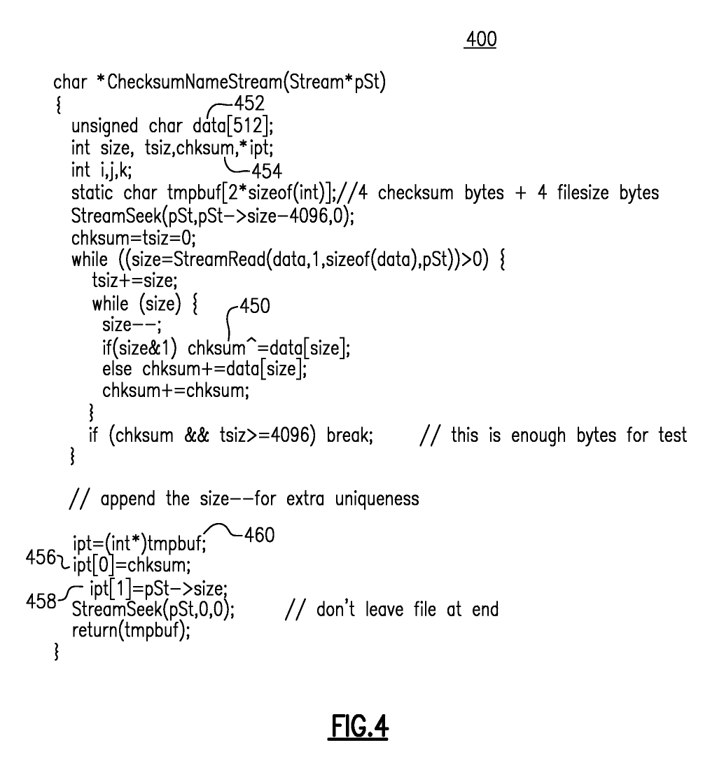

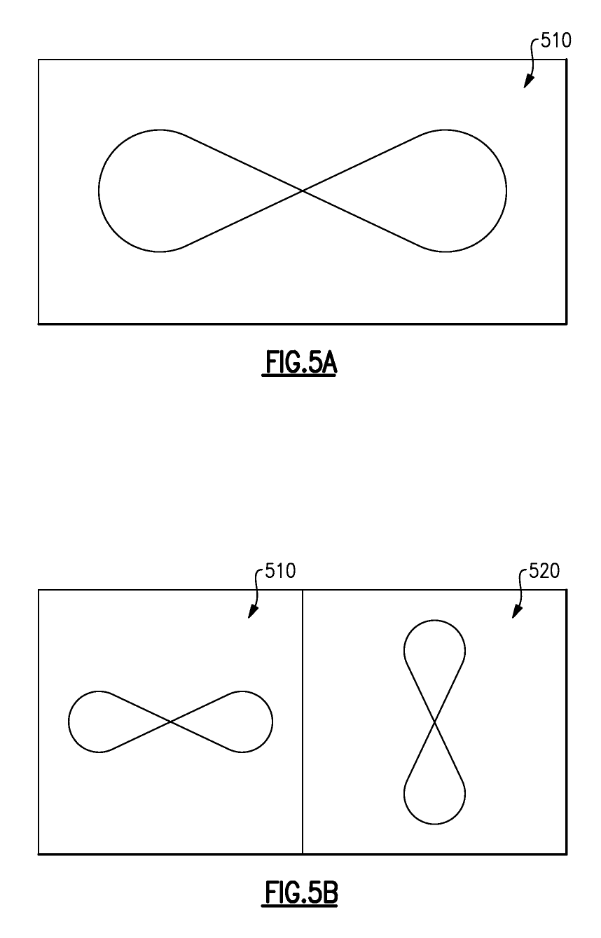

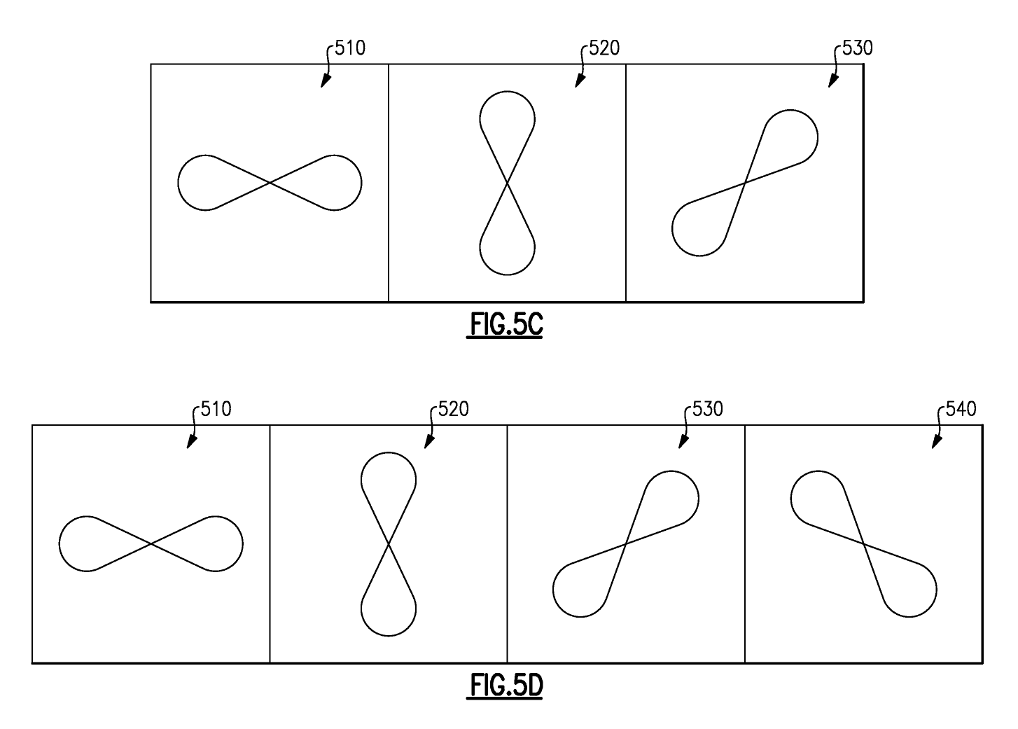

Optionally, the software can be configured to notify the user of the non-duplicate images and to query (ask) the user regarding which one or more image file(s) to display. Alternatively, in other embodiments, the DPF 110 can be configured to instead notify the user of the existence of any duplicate image files stored onto the external memory card and to query (ask) the user if the duplicate files should not be transferred from the external memory card device or processed in some other manner. FIGS. 5A-5D illustrate a dynamic image display (rendering) scenario according to one embodiment of the invention. A dynamic image display (rendering) component, controls the DPF 110 to dynamically display (render) a plurality of images during a period of time, also referred to as a dynamic image display (rendering) time period.

In some embodiments, the dynamic image display (rendering) component is implemented as software residing internal to the DPF 110. The dynamic image display component that is configured to direct operation of the display screen 112 so that a plurality of image files are displayed during a predetermined dynamic image display time period.

The dynamic image display time period has an associated set of display directives, each set of the display directives has an associated set of display attributes. The set of display directives collectively specifies a rendering of each of the plurality of image files. Each of the image files are identified by and associated with an image file identifier. Each image file is also associated with at least one rendering action. Each rendering action is associated with an initial rendering time, a final rendering time, and at least one rendering area.

In this scenario, the dynamic image rendering period has a duration of 20 seconds and the image display 112, also referred to as a display 112, has a resolution of 480 pixels (horizontal) and 234 pixels (vertical). The image display 112 includes a matrix of pixels that forms a rectangle of 480 columns and 234 lines of pixels.

FIG. 5A illustrates, in accordance with this scenario, a first rendering of a first image 510 of a first image file. As shown, the first image 510 is that of a symbol appearing like a number eight (having a clockwise rotation of about 90 degrees) in the foreground surrounded by a white background. In this scenario, the first image 510 is the first in a sequence of multiple images to be rendered within the dynamic image display (rendering) period. The first image 510 is initially rendered at time=0 seconds offset within the dynamic image rendering period. Hence, the first image 510 is associated with a rendering action including an initial rendering time equal to 0 seconds and a rendering area described below. The first rendering of the first image 510 is in accordance with a first rendering action associated with the second image 510.

Accordingly, the first rendering action also includes a rendering area that is coupled to the initial rendering time. The dimension of the first rendering area of the first image is currently 480 pixels wide (horizontal) and 234 pixels high (vertical), and the first rendering location (lowest and leftmost pixel of the first image) of the first image is equal to the lowest and left most pixel of the image display 112, having corresponding pixel coordinates equal to pixel location (0,0) within the image display 112. Furthermore, in this scenario, the first rendering duration period of the first image 510 is equal to 5 seconds.

FIG. 5B illustrates, in accordance with the embodiment of dynamic image display of FIG. 5A, a simultaneous rendering of the first 510 and second 520 images. This figure illustrates, in accordance with the embodiment of dynamic image display of FIG. 5A, a first rendering of a second image 520 in combination with a first rendering of the first image 510. As shown, the second image 520 is that of a symbol appearing like a number eight (without any rotation), in the foreground surrounded by a white background.

In this scenario, the second image 520 is the second in a sequence of multiple images to be rendered within the dynamic image rendering period. The second image 520 is initially rendered at time=5 seconds offset within the dynamic image rendering period. As shown, the first rendering of the second image 520 has an associated rendering area equal to and occupying a right half of the entire image display 112, while the second rendering of the first image 510 has an associated rendering area equal to and occupying a left half of the entire image display 112. The first rendering of the second image 520 is in accordance with a first rendering action associated with the second image 520.

Accordingly, the dimension of the first rendering area of the first rendering action of the second image 520 is currently (480/2=240) pixels wide (horizontal) and 234 pixels high (vertical), and the first rendering location (lowest and leftmost pixel) of the second image 520 is equal to the lowest and center most pixel of the image display 112, having corresponding pixel co-ordinates equal to pixel location (0,240) within the image display 112. In this scenario, like that of the first rendering of the first image 510, the first rendering of the second image 520 is for a duration period equal to 5 seconds.

As shown, the dimension of the second rendering area of the of the first image 510 (rendering area of the second rendering action of the first image 510) has changed and is currently (480/2=240) pixels wide (horizontal) and 234 pixels high (vertical), and the second rendering location (lowest and leftmost pixel) of the first image 510 is currently equal to the lowest and leftmost pixel of the image display 112, having corresponding pixel co-ordinates equal to pixel location (0,0) within the image display 112. The second rendering duration of the first image 510 is equal to 5 seconds.

FIG. 5C illustrates, in accordance with the embodiment of dynamic image display of FIGS. 5A-5B, a simultaneous rendering of the first 510, second 520 and third 530 images. This figure illustrates, in accordance with the embodiment of dynamic image display of FIGS. 5A-5B, a first rendering of a fourth image 540 in combination with a second rendering of the second image 520 and a third rendering of the first image 510. As shown, the fourth image 540 is that of a symbol appearing like a number eight (having a clockwise rotation of about 45 degrees), in the foreground surrounded by a white background.

In this scenario, the fourth image 540 is the third in a sequence of multiple images to be rendered within the dynamic image rendering period. The fourth image 540 is initially rendered at time=10 seconds offset within the dynamic image rendering period. As shown, the first rendering of the fourth image 540 has an associated rendering area equal to and occupying a rightmost third portion of the entire image display 112, while the second rendering of the second image 520 has an associated rendering area equal to and occupying a middle third portion of the entire image display 112 and the third rendering of the first image 510 has an associated rendering area equal to and occupying a leftmost third portion of the entire image display 112.

Accordingly, the dimension of the first rendering area of the third image 530 is currently (480/3=160) pixels wide (horizontal) and 234 pixels high (vertical), and the first rendering location (lowest and leftmost pixel) of the third image 530 is equal to the lowest and leftmost pixel of the rightmost third portion of the image display 112, having a corresponding pixel co-ordinate value equal to pixel location (0,320) within the image display 112. The rendering duration period of the first rendering of the third image 530, the second rendering of the second image 520 and the third rendering of the first image are equal to 5 seconds.

As shown, the dimension of the second rendering area of the second image 520 (rendering area of the second rendering action of the second image 520) has changed and is currently (480/3=160) pixels wide (horizontal) and 234 pixels high (vertical), and the second rendering location (lowest and leftmost pixel) of the second image 520 is currently equal to the lowest and leftmost pixel of the middle third portion of the image display 112, having a corresponding pixel co-ordinate equal to pixel location (0,160) within the image display 112. The second rendering duration of the second image 520 is equal to 5 seconds.

As shown, the dimension of the third rendering area of the first image 510 (rendering area of the third rendering action of the first image 510) has changed and is currently (480/3=160) pixels wide (horizontal) and 234 pixels high (vertical), and the third rendering location (lowest and leftmost pixel) of the first image 510 is currently equal to the lowest and leftmost pixel of the image display 112, having corresponding pixel co-ordinates equal to pixel location (0,0) within the image display 112. The third rendering duration of the first image 510 is equal to 5 seconds.

FIG. 5D illustrates, in accordance with the embodiment of dynamic image display of FIGS. 5A-5C, a simultaneous rendering of the first 510, second 520, third 530 and fourth 540 images. This figure illustrates, in accordance with the embodiment of dynamic image display of FIGS. 5A-5C, a first rendering of a fourth image 540, in combination with a second rendering of the third image 540, third rendering of the second image 520 and a fourth rendering of the first image 510. As shown, the fourth image 540 is that of a symbol appearing like a number eight (having a counter clockwise rotation of about 45 degrees), in the foreground surrounded by a white background.

In this scenario, the fourth image 540 is the fourth in a sequence of multiple images to be rendered within the dynamic image rendering period. The fourth image 540 is initially rendered at time=15 seconds offset within the dynamic image rendering period for a first rendering period equal to 5 seconds. As shown, the first rendering of the fourth image 540 has an associated rendering area equal to and occupying a rightmost quarter portion of the entire image display 112, while the second rendering of the third image 530 has an associated rendering area equal to and occupying a second rightmost quarter portion of the entire image display 112 and the third rendering of the second image 520 has an associated rendering area equal to and occupying a second leftmost quarter portion of the entire image display 112.

Accordingly, the dimension of the first rendering area of the fourth image 540 is currently (480/4=120) pixels wide (horizontal) and 234 pixels high (vertical), and the first rendering location (lowest and leftmost pixel) of the fourth image 540 is equal to the lowest and leftmost pixel of the rightmost quarter portion of the image display 112, having a corresponding pixel co-ordinate value equal to pixel location (0,360) within the image display 112. The rendering duration period of the first rendering of the fourth image 540, the second rendering of the third image 530 and the third rendering of the second image 520 and the fourth rendering of the first image 510 are equal to 5 seconds.

As shown, the dimension of the second rendering area of the third image 530 (rendering area of the second rendering action of the third image 530) has changed and is currently (480/4=120) pixels wide (horizontal) and 234 pixels high (vertical), and the second rendering location (lowest and leftmost pixel) of the third image 530 is currently equal to the lowest and leftmost pixel of the second rightmost quarter portion of the image display 112, having a corresponding pixel co-ordinate equal to pixel location (0,240) within the image display 112. The second rendering duration of the second image 520 is equal to 5 seconds.

As shown, the dimension of the third rendering area of the second image 520 (rendering area of the third rendering action of the second image 520) has changed and is currently (480/4=120) pixels wide (horizontal) and 234 pixels high (vertical), and the third rendering location (lowest and leftmost pixel) of the second image 520 is currently equal to the lowest and leftmost pixel of the second leftmost quarter portion of the image display 112, having a corresponding pixel co-ordinate equal to pixel location (0,120) within the image display 112. The third rendering duration of the second image 520 is equal to 5 seconds.

As shown, the dimension of the fourth rendering area of the first image 510 (rendering area of the fourth rendering action of the first image 510) has changed and is currently (480/4=120) pixels wide (horizontal) and 234 pixels high (vertical), and the fourth rendering location (lowest and leftmost pixel) of the first image 510 is currently equal to the lowest and leftmost pixel of the leftmost quarter portion of the image display 112, having a corresponding pixel co-ordinate equal to pixel location (0,0) within the image display 112. The fourth rendering duration of the second image 510 is equal to 5 seconds.

At a time of 20 seconds offset within the dynamic image rendering period, the dynamic display sequence ends. In some embodiments, another dynamic display sequence initiates using a different set and/or a different sequence of images. In other embodiments, the dynamic display sequence repeats for a limited number of cycles. In some embodiments, each set of images for dynamic display is automatically selected using a selection algorithm.

In other embodiments, different dynamic display algorithms can be employed. For example, instead of varying individual the size of rendering areas as a function of time within the dynamic image rendering time period, a plurality of rendering areas are defined and that are fixed in size through out the dynamic image rendering period.

In this embodiment, each of a plurality of image files are rendered within one of the fixed size rendering areas for at least a portion of the dynamic image rendering time period. In a variation of this embodiment, each of the plurality of images are rendered in a round robin fashion into one or more of the rendering areas of fixed size.

For example, within a first dynamic image display period, a first image file is rendered into a first rendering area and a second image file is rendered into a second rendering area at an initial rendering time=0. The first image file and the second image file and each rendered for a duration of 5 seconds. At an initial rendering time=5 seconds, the second image is rendered into the first rendering area and a third image is rendered into the second rendering area for a duration of 5 seconds. At an initial rendering time=10 seconds, the third image is rendered into the first rendering area and a fourth image is rendered into the second rendering area for a duration of 5 seconds. At an initial rendering time=15 seconds, the fourth image is rendered into the first rendering area and the first image is rendered into the second rendering area for a duration of 5 seconds.

At an initial rendering time=20 seconds, which is equal to time=0 seconds to start a second dynamic image display period, the first image is rendered into the first rendering area and the second image is rendered into the second rendering area for a duration of 5 seconds, to repeat the cycle of rendering the first, second, third and fourth images.

In a variation of the above scenario, the first and second rendering areas are of unequal size. In another variation, each image of the plurality of images is selected randomly for rendering within the first or second rendering areas. In yet another variation, the initial rendering times for each of the first and second rendering areas are not equal. For example, the rendering times for the first rendering area are 0, 5 and 15 seconds, and for the second rendering area are equal to 0 and 10 and 15 seconds.

While the present invention has been explained with reference to the structure disclosed herein, it is not confined to the details set forth and this invention is intended to cover any modifications and changes as may come within the scope and spirit of the following claims.

What is claimed is:

1. A digital picture frame including:
a chassis;
an internal memory that is located within said chassis and that is configured for storing a first set of image files;
an display screen that is configured for displaying an image stored within at least one of said first set of image files at any one time;
an input port that is configured for inputting at least one of a second set of image files that are stored onto an external memory located outside of said chassis;
an image file filtering component that is configured to uniquely identify each member of said first set of image files, and configured to uniquely identify each member of said second set of image files, and configured to uniquely identify each member of a third set of image files; and where
each member of said third set of image files is a member of said second set of image files, but is not a duplicate of any member of said first set of image files.

2. The digital picture frame of claim 1 where said image files of said first set, of said second set and of said third set, each include digital data, and where at least a portion of said digital data included within an image file is mapped to at least one image file identifier associated with said image file, and where each said image file identifier is configured to uniquely identify each associated said image file so that if a first image file is identical to a second image file, then a first image file identifier associated with said first image file is identical to a second image file identifier associated with said second image file identifier.

3. The digital picture frame of claim 2 where a said at least a portion of digital data is input into an file identification procedure to determine said file identifier.

4. The digital picture frame of claim 2 where said file identification procedure is characterized as a checksum algorithm.

5. The digital picture frame of claim 1 where said image filtering component includes a processor and software, and where said software directs the operation of said processor.

6. The digital picture frame of claim 1 that is configured so that upon an occurrence of an event of establishing communication between said external memory and said input port, said digital picture frame detects said event and transfers said third set of image files from said external memory to said internal memory without requiring user or other human intervention after said occurrence of said event.

7. The digital picture frame of claim 6 where said event occurs upon establishing a physical (wireline) communications connection between said external memory and said input port.

8. A digital picture frame including:
a chassis;
an internal memory that is located within said chassis and that is configured for storing a first set of images;
an display screen that is configured for displaying at least one of said first set of image files at any one time;
an input port that is configured for inputting at least one of a second set of image files that are stored onto an external memory;
a image filtering component that is configured to uniquely identify each member of said first set of image files, and configured to uniquely identify each member of said second set of image files, and configured to uniquely identify each member of a third set of image files; and where
each member of said third set of image files is a member of said second set of image files, but is not a duplicate of any member of said first set of image files; and wherein
upon an occurrence of an event of establishing communication between said external memory and said input port, said digital picture frame detects said occurrence of said event and transfers said third set of images from said external memory to said internal memory without requiring user or other human intervention after said occurrence of said event.

9. The digital picture frame of claim 8 where said digital picture frame further performs an action of displaying an image included within at least one of said third set of image files without requiring user or other human intervention after said occurrence of said event.

10. A digital picture frame including:
an internal memory that is configured for storing a first set of image files;
a display screen that is configured for displaying a plurality of image files at any one time;
a dynamic image display component that is configured to direct operation of said display screen so that at least a subset of said first set of image files is displayed during a predetermined dynamic image display time period, said dynamic image display time period having an associated set of display directives, each of said display directives having an associated set of display attributes; and
wherein said set of display directives specify rendering of each of said plurality of image files, each of said image files are each associated an image file identifier, and associated with at least one rendering action, said rendering action being associated with an initial rendering time, a final rendering time, and at least one rendering area.

11. The digital picture frame of claim 10 wherein said rendering area includes information specifying a rendering area location, a rendering area width and a rendering area height, said information defining at least a portion of said display within which an image file is rendered.

12. The digital picture frame of claim 10 wherein said set of display directives are configured to render a plurality of image files during one same time period.

13. The digital picture frame of claim 12 wherein said plurality of image files are each rendered onto non-overlapping and equally sized rendering areas during one same time period.

14. The digital picture frame of claim 12 wherein each of said plurality of image files are rendered into non-overlapping and non-equally sized rendering areas during one same time period.

15. The digital picture frame of claim 12 wherein each of said plurality of image files are each rendered into a same rendering area during non-overlapping time periods within said dynamic image display time period.

16. The digital picture frame of claim 12 wherein each of said plurality of image files are rendered into non-equally sized rendering areas during one same time period.

17. The digital picture frame of claim 12 wherein each of said plurality of image files is rendered at an initial rendering time and is rendered at a final rendering time substantially equal to an end of said dynamic image display time period.

18. The digital picture frame of claim 12 wherein at least one of said plurality of image files is not rendered at a final rendering time substantially equal to an end of said dynamic image display time period.

19. A digital picture frame including:
a chassis;
an internal memory that is located within said chassis and that is configured for storing a first set of image files and configured for storing a software program;
an display screen that is configured for displaying at least one of said first set of image files at any one time;
an input port that is configured for inputting at least one of a second set of image files that are stored onto an external memory; and
upon an occurrence of an event of establishing communication between said external memory and said input port, said digital picture frame is configured to detect said occurrence of said event and to transfer at least one of said second set of image files that are stored onto said external memory, without requiring user or other human intervention after said occurrence of said event.

20. A digital picture frame including:
a chassis;
an internal memory that is located within said chassis and that is configured for storing a first set of image files and configured for storing a software program;
an display screen that is configured for displaying at least one of said first set of image files at any one time;
a motion sensor that is configured for detecting a motion event occurring within proximity of said chassis; and where an operating mode of the digital picture frame is selected based upon an occurrence of detecting said motion event.
